(19) United States
(12) Patent Application Publication
(10) Pub. No.: US 2006/0261082 A1
(43) Pub. Date: Nov. 23, 2006

(54) Food handling system

(76) Inventors: Robert Almblad, Tarpon Springs, FL (US); Jay M. Almblad, Grayslake, IL (US)

Correspondence Address: Arthur W. Fisher, III, Suite 316, 5553 West Waters Avenue, Tampa, FL, 33634, US

(21) Appl. No.: 11/435,055

(22) Filed: May 16, 2006

Related U.S. Application Data
(60) Provisional application No. 60/682,475, filed on May 18, 2005.
(60) Provisional application No. 60/682,478, filed on May 18, 2005.

(51) Int. Cl. G07F 11/00

(52) U.S. Cl. 221/260

(57) ABSTRACT

A food handling system to store and dispense food products disposed within protective packaging comprises a food storage assembly to retain the food products to be dispensed therefrom and a food dispensing assembly to separate the food products from the protection packaging to dispense the food products.

### CROSS-REFERENCE

This is a non-provisional application of provisional applications Ser. No. 60/682,475, filed May 18, 2005, entitled Delaminator and Ser. No. 60/682,478, filed May 18, 2005, entitled Fan Fold Food Package.

### BACKGROUND OF THE INVENTION

1. Field of Invention

A food handling system to store and dispense food products therefrom.

2. Background of the Invention

There is a large amount of activity in the general field of restaurant automation in context of hygienic handling of various food product(s), and several studies and researches as well as invention(s) have delved upon the subject(s) of ‘packaging’ and ‘unpackaging’ procedures/methods. Protocols such as lamination, sheet-layering, foil packaging and peeling off, dismantling and delamination, at the manufacture sites (food processing factories/units) and usage sites (restaurants, hotels and eating points) are known to be in existence in the prior art profile.

The prior art discloses patents on delamination of a laminate, use of conveyor belts to transport laminated food products from one place to other, as well as use of several methods for unpacking the laminated food products such as peeling of film, delamination of laminated food and also in some cases the deployment of stripper unit. However, the prior art profile does not eliminate the need of human interference such as the food product directly passed on to a cooking unit.

U.S. Pat. No. 5,141,584 issued in favour of Schuh et al discloses an invention focusing on an apparatus and method for delaminating a composite sheet structure of the kind comprising a vertically frangible layer having a first surface adhesively bonded to a first sheet at a substantially uniform strength and an opposite surface abutting areas which are, respectively, adhesively bonded to a second sheet at strengths less or greater than the uniform strength and having a marginal portion or tab extending beyond the first sheet. The composite sheet structure is fed into the nip of upper and lower peel rollers and upon passage therethrough a strip sheet roller is rotated into position to bend and hold the laminate against the upper peel roller in a position to fracture the tab from the first sheet. On reversal of the feed direction and passage of the laminate back through the nip of the strip sheet and upper peel rollers, the thicker “keeper sheet” of the flexed laminate breaks from the “throw-away” sheet containing the tab at the preformed tab. A roller configuration and drive train structure are provided that provides a more predictable and repeatable steady state condition and allows for control of the location of the peel point to be accomplished.

European Patent No. EP 0749896 issued in favour of Richard Beer discloses a method and device for packaging or unpackaging portions of a deep frozen food product. The invention provides details about how the process packs portions of a low temperature foodstuff are first arranged with longitudinal separations in a row behind one another. The portions are guided between two strips (9,10) of foil packaging which are then combined in order to form a ribbon (14). The portions may be placed in chambers in one of the strips, which are arranged along it with equal spacings. Each strip may also have half-chambers (11a, 11b), and may be guided together in order to align corresponding half-chambers with each other prior to the introduction of a portion into one or both of them.

U.S. Pat. No. 4,183,751 issued in favour of Matsumoto et al discloses a process for developing a photosensitive material and a device therefore are disclosed wherein an image on a photosensitive material consisting of a cover base laminated through the intermediary of a photosensitive layer to a support member is developed into a visible image by stripping the cover base from the support member. A preliminary stripping step of stripping the cover base from the support member in the leading end portion thereof is first performed. This is immediately followed by the reorientation of the leading end portion of the cover base to bring the same into registration with the support member. Therefore, a final stripping step is performed wherein the cover base is successively separated from the leading end portion thereof towards the trailing end thereof from the support member.

U.S. Pat. No. 4,508,589 issued in favour of Tarui et al discloses an apparatus for stripping a protective coating from a substrate such as an architectural ornament or copper-plated resin board. First and second rotatable rollers are mounted parallel to one another with the spacing therebetween being adjustable. Discharge units are mounted above and below, respectively, the two rotatable rollers. An adhesive roller projects beyond the surface of each of the rollers through an aperture formed therein. Adhesive tape is wound around the adhesive rollers with the sticky side of the tape to the outside. A push rod is selectively extendible through an aperture formed in the rollers to the rear, in the direction of rotation of the rollers, the position of the adhesive rollers. Protective coating, taken up onto the surface of the rotatable rollers by action of the adhesive rollers, is transferred from the surface of the rotatable rollers to the discharge units, and then discharged to the outside.

U.S. Pat. No. 4,670,085 issued in favour of van der Meer et al discloses an apparatus for peeling positive print sheets from disposable components of peel-apart diffusion transfer film unit assemblies which comprises an open bottom chassis capable of being positioned over a receptacle and supporting a rotatable drum for carrying a processed film unit assembly into operative relationship with peeling blade assemblies to remove the print and release the remaining components of the film assembly for disposal through the open bottom of the chassis. The peeling components engage only marginal portions of the print and involve a combination of a movable peeling blade to engage the leading marginal edge of the print and a pair of fixed peeling blades which engage the side margins of the print and retain the print for manual removal from the apparatus.

U.S. Pat. No. 5,169,475 issued in favour of Tobin et al discloses an apparatus and method for a delamination medium. The invention provides for a novel laminar sheet structure having at least two sheets of different stiffnesses in releasably adhering engagement with each other, the sheet of the lesser stiffness having a marginal portion extending beyond on adjacent margin of the sheet with the greater stiffness. Also disclosed is an apparatus for delaminating the laminar sheet structure having at least one rotatably mounted roller with an axial slot in its peripheral surface for receiving the marginal portion of the sheet of lesser stiffness so that the sheet may be wound upon the roller while the sheet of greater stiffness is separated therefrom and a method of delaminating the structure by the apparatus.

U.S. Pat. No. 6,244,019 issued in favour of Ljungqvist discloses a system for packaging and unpackaging can lids. The invention relates to packages for stacked can lids, a method of producing such packages, devices for implementing said method, devices for automated unpacking of the above nature and a system for packing and unpacking can lids. The packages are formed with an open end, which is closed in that the bag end, when in unfolded condition, is compressed and is provided with fastening means retaining said closed condition. In addition, the closing device closes the open package end by compressing the bag end in the unfolding condition and in that fastening means are applied retaining said closed condition, and the unpacking device causes relative movement of the packages and the can lids contained therein in such a manner that the can lids are pressed against the package end closed by means of said fastening means.

The invention under Patent NL 9201286 discloses an invention relating to a device for unpacking a longitudinal row of disc-like objects, such as lids (covers), which are held in a package comprising: i) a feed conveyor for the objects which are accommodated in the package; ii) a locating unit for locating and positioning a marker which is arranged on the package; iii) a cutting unit for making a longitudinal seam in the package over at least part of its length; iv) a stripper unit for stripping off the package sideways; v) a depositing device for depositing the row of objects on at least one discharge conveyor; and vi) a discharge unit for the packaging which has been stripped off.

Patent JP 8324524 issued in favour of Hayakawa et al pertains to a film separator. The purpose of the invention is to easily separate a film by bringing a pair of upper and lower film catching rollers into contact with a side of a pallet, rotating both rollers oppositely to each other, catching a lower end of a cut film of a remaining part between both rollers and then retreating the rollers.

Patent JP 11292043 issued in favour of Mashahiro et al discloses a film separation equipment and identifies the problem to be solves as to catch the end of a film more surely than conventional equipment by retreating a group of top/bottom rollers for separating the film from the side face of a pallet when the top roller is lowered and the film is held and caught between the top/bottom rollers.

Patent JP 4258945 issued in favour of Tobin discloses an invention to obtain a peeling device for a composite sheet of a specified structure in which a layer can be selectively peeled by using a roller having a slot along the axial direction on the outer surface and using an inserting means to insert a composite sheet of a specified structure into the slot.

Patent JP 5221434 issued in favour of Kenichi discloses an invention to reduce the disposal volume of a packing paper after blank form sheets are taken out, to improve the utility. An unpacking device includes a cut-opening device 70 which cuts open a side of a packing paper 2, a conveyer 13 which takes out blank form sheets from the packing paper 2 that is cut open, and a removal device 80 which removes the packing paper 2 that is cut open. The removal device 80 has at least feed reels 82A and 82B that supply a pair of flexible connecting members 81A and 81B which face each other, and a roll-up reel 83 which rolls up at least the pair of the flexible connecting members 81A and 81B. The packing paper 2 that is cut open is introduced in between at least the pair of the flexible connecting members 81A and 81B and rolled up by the roll-up reel 83 together with the flexible connecting members 81A and 81B.

Patent EP 0681918 issued in favour of Obermiller et al discloses a system for sheetwise dry processing thermographic print media is disclosed. The media is a laminate of a substrate with an attached frangible tab, a peel sheet and an adhesive image forming layer. A feeder feeds the sheets one at a time from a first position and orientation to a second position and orientation with the tab at a trailing end. A print roller is mounted for reversible rotation in infeed and outfeed directions. The print roller has clamps for engaging the sheet as received from the sheet feeder. A thermal printer cooperates with the print roller for thermally exposing the substrate. A peeler receives the sheet from the print roller with the tab at the leading edge. The peeler captures the film and engages the tab bending the substrate about the score line causing it to fracture. The peeler pulls the substrate and adhered image layer apart from peeler sheet to thereby produce a peeled substrate with an image layer and a waste peeler sheet. A thermal laminator receives the substrate and image layer for thermal laminating engagement with a thermosensitive film having a thermosensitive layer □ransferable to the image layer of the substrate. The film is thereafter stripped from the structure and the substrate transferred to a discharge receptacle.

Patent DE 10147036 issued in favour of Koenig et al discloses a process for delaminating a material from a laminate and then laminating a second material to the remaining laminate comprising placing the laminate on a roller, removing a primary layer, placing a second material on the remaining laminate using a second arrangement and removal from the roller.

The features of the afore-mentioned prior art disclose complex design and bulky structural indices thereby hindering utilization in restaurant automation devices. Moreover, none addresses the use of restaurant automation in highly aseptic conditions by eliminating human interference during transfer of food products from refrigerated storage to cooking unit. Such a device or apparatus necessitates the need for a new packaging and un-packaging device incorporating simple structural indices and reliability in operation without compromising on the hygienic transfer under aseptic conditions.

### SUMMARY OF THE INVENTION

The present invention relates to a food handling system to store and dispense food products comprising a food storage assembly to store the food products therein and a food dispensing assembly to dispense the food products from the food handling system.

The food products may comprise hamburger patties or other meat foodstuffs such as ham, salami, fish, lamb or the like and vegetarian foodstuff such as spinach, cucumber, tomato or the like. In addition, the food products may comprise condiments such as ketchup, mustard, mayonnaise or the like.

Such food products are packaged between a pair of elongated strips of flexible material or film sealed together to cooperatively form a continuous laminated food strip to protect the food products therebetween for storage within the food storage assembly until the elongated strips of flexible material or film are separated by the food dispensing assembly to dispense the food products from the food handling system as described more fully hereinafter. The food products are fan folded as a series of food products stacked one upon another in a dispensing configuration or disposition when stored within the food storage assembly.

The food storage assembly comprises a storage enclosure or carton to house and support the plurality of food products in the fan folded configuration.

The food dispensing assembly comprises a pair of film take-up devices each coupled to the leading end portion of a corresponding elongated strip of flexible material or film.

The food dispensing assembly further includes a food strip directional control to change the direction of travel of the continuous laminated food strip directed to the food dispensing assembly by a laminated food strip guide disposed with the food storage assembly. The food strip direction control comprises a pair of directional control surfaces each disposed to engage the outer surface of one of the elongated strips of flexible material or film.

When so configured, a drive means rotates each film take-up device to separate the pair of elongated strips of flexible material or film from each other allowing the food products to drop or fall onto a conveyor or other surface.

The invention accordingly comprises the features of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a front view of the food handling system of the present invention with the food dispensing assembly stored within the food storage assembly.

FIG. 2 is a front view of the food handling system of the present invention with the food dispensing assembly deployed in the dispensing configuration.

FIG. 3 is a perspective view of a food product hygienically encased within a continuous laminated food strip.

FIG. 4 is a partial exploded view of the upper portion of the food product storage enclosure or carton of the present invention showing the food dispensing assembly.

FIG. 5 is a partial detailed schematic front view of the food dispensing assembly of the present invention deployed in the dispensing configuration.

FIG. 6 is a partial perspective view of the food dispensing assembly of the present invention deployed in the dispensing configuration.

FIGS. 7a through 7c schematically depict different dispositions of the film strip take-up devices relative to the food strip directional control.

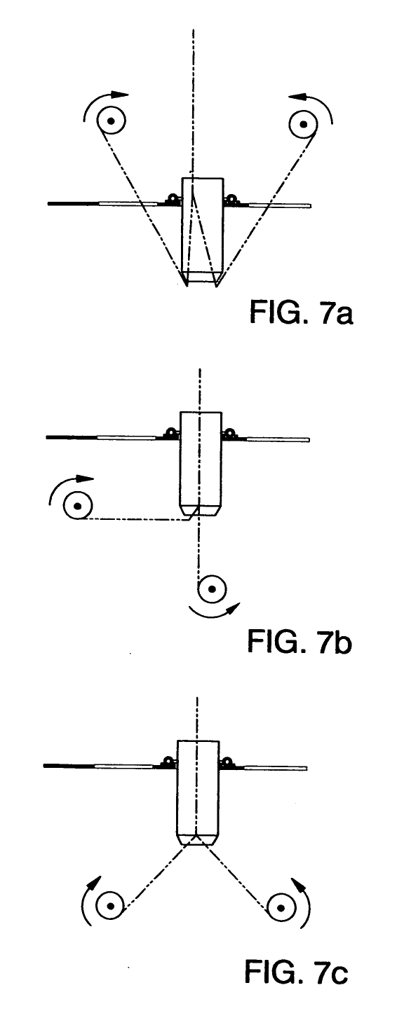

Similar reference characters refer to similar parts throughout the several views of the drawings.

### DETAILED DESCRIPTION OF THE PREFERRED EMBODIMENT

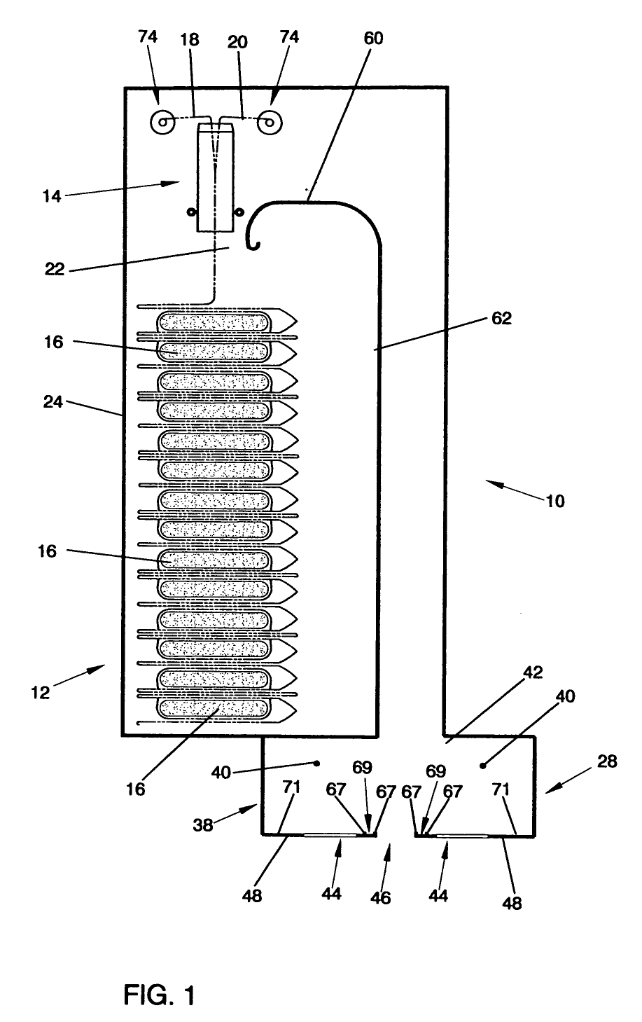

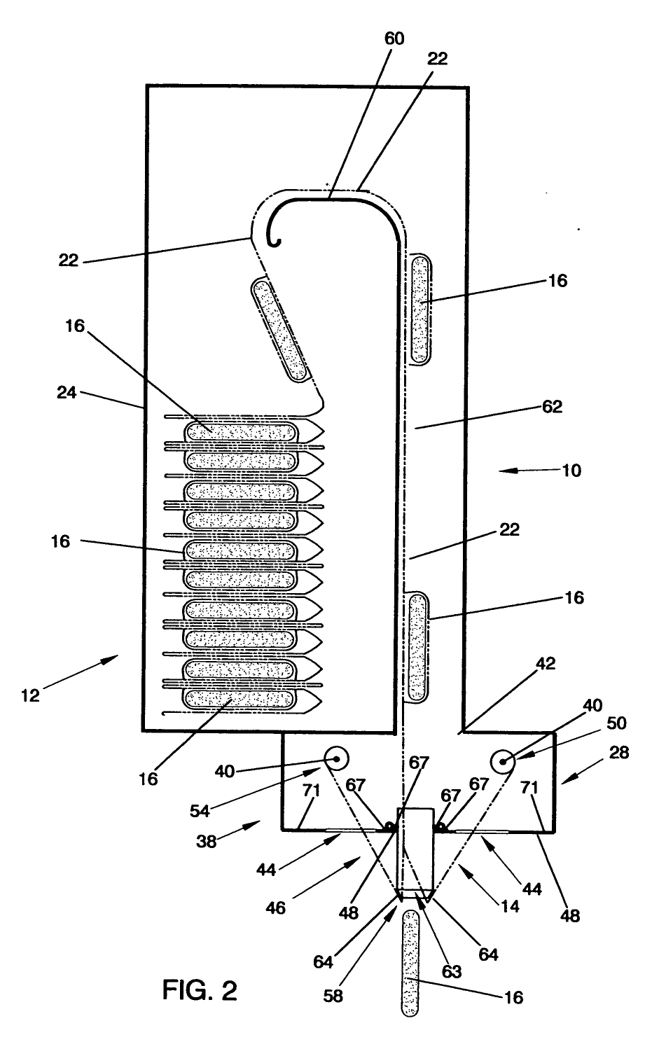

As best shown in FIGS. 1 and 2, the present invention relates to a food handling system generally indicated as 10 to store and dispense food products comprising a food storage assembly generally indicated as 12 to store the food products therein and a food dispensing assembly generally indicated as 14 to dispense the food products from the food dispensing assembly 14 of the food handling system 10.

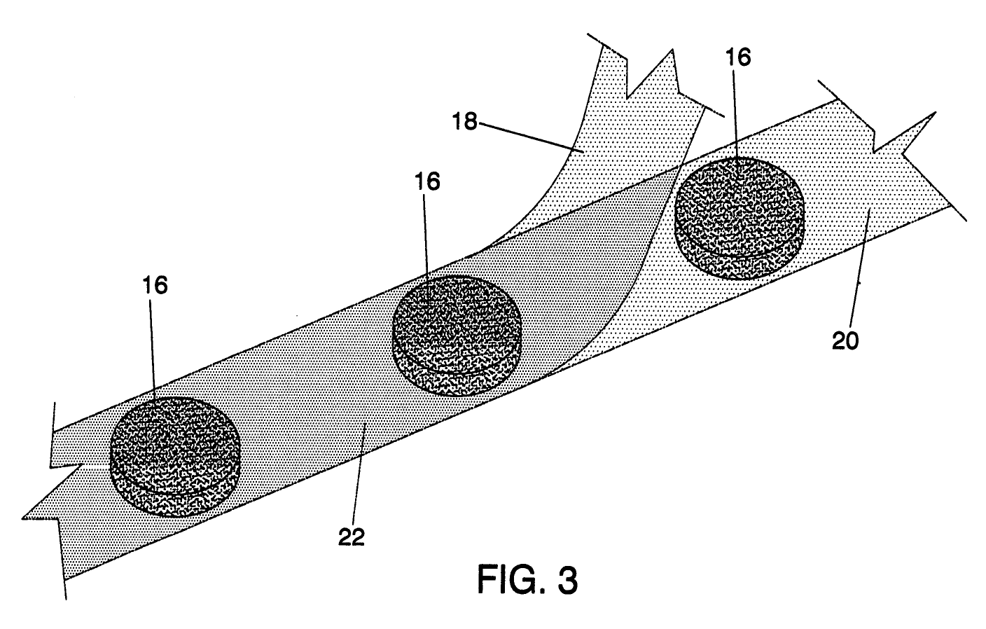

As shown in FIG. 3, the food products such as a hamburger patty 16 are packaged between a first elongated strip of flexible material or film 18 and a second elongated strip of flexible material or film 20. The first elongated strip of flexible material or film 18 and the second elongated strip of flexible material or film 20 may be sealed together by heat and/or pressure to cooperatively form a continuous laminated food strip 22 to protect the food products 16 therebetween for storage within the food storage assembly 12 until the first elongated strip of flexible material or film 18 and the second elongated strip of flexible material or film 20 are separated by the food dispensing assembly 14 to dispense the food products 16 from the food handling system 10 as described more fully hereinafter. The food products may comprise a hamburger patty 16 as shown or other meat foodstuffs such as ham, salami, fish, lamb or the like and vegetarian foodstuff such as spinach, cucumber, tomato or the like. In addition, the food products may comprise condiments such as ketchup, mustard, mayonnaise or the like.

As shown in FIGS. 1 and 2, the food products 16 are fan folded as a series of food products 16 stacked one upon another in a dispensing configuration or disposition when stored within the food storage assembly 12. As will be evident, the food products 16 are stored and dispensed onto a dish, conveyor or other surface (not shown) in a hygienic manner without handling or touching by a human operator.

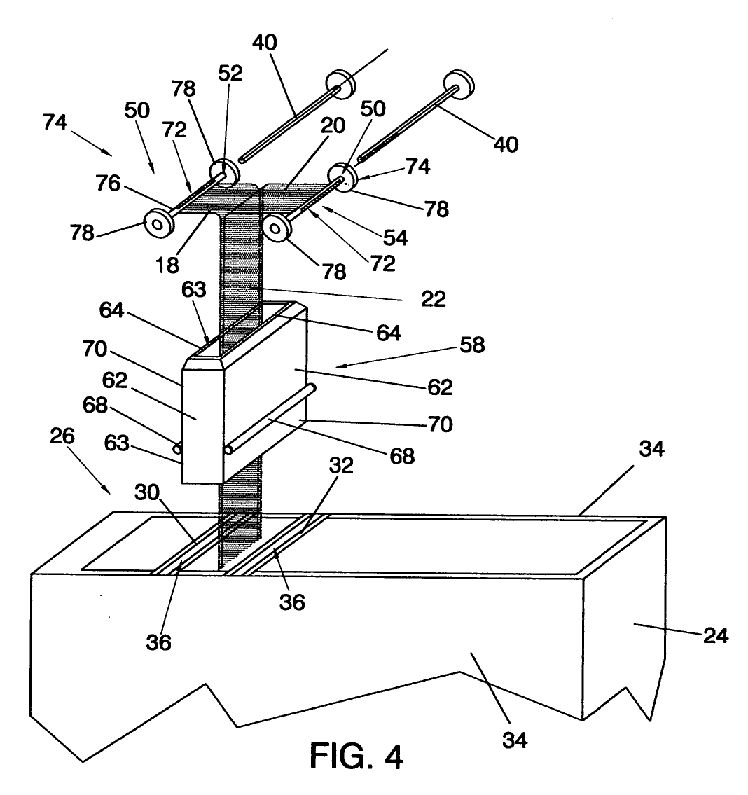

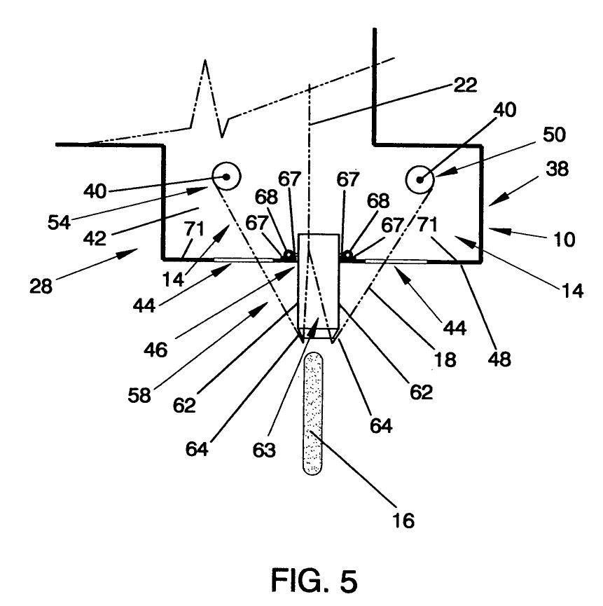

As best shown in FIGS. 1 and 2, the food storage assembly 12 comprises a hollow food product storage enclosure or carton 24 to house and support the plurality of food products 16 sealed or disposed between the first elongated strip of flexible material or film 18 and the second elongated strip of flexible material or film 20 of the continuous laminated food strip 22 stacked in the fan folded configuration. As shown in FIG. 4, a food dispensing assembly storage support generally indicated as 26 is disposed in the upper portion of the hollow food product storage enclosure or carton 24 of the food storage assembly 12 to support the food dispensing assembly 14 before use. As shown in FIGS. 1 and 2, a food dispensing assembly support generally indicated as 28 is disposed on the lower portion thereof to operatively support the food dispensing assembly 14 when deployed to separate the first elongated strip of flexible material or film 18 and the second elongated strip of flexible material or film 20 to dispense the food products 16 serially and individually from the food dispensing assembly 14 of the food handling system 10 as best shown in FIGS. 2 and 5.

As best shown in FIG. 4, the food dispensing assembly storage support 26 comprises a first food dispensing assembly support member 30 and a second food dispensing assembly support member 32 extending between the upper portion of opposite side walls each indicated as 34 of the hollow food product storage enclosure or carton 24. The first food dispensing assembly support member 30 and the second food dispensing assembly support member 32 each includes a groove or channel 36 to receive and support a portion of the food dispensing assembly 14 as described more fully hereinafter.

As shown in FIGS. 1, 2 and 5, the food dispensing assembly support 28 comprises a food dispensing assembly support housing generally indicated as 38 having a pair of rotatably mounting members or pins each indicated as 40 mounted to a substantially vertically disposed support wall or member 42 and a pair of film separation slots or openings each indicated as 44 and a centrally dispensed laminated strip opening 46 formed through a substantially horizontally disposed lower wall 48 extending outwardly from the substantially vertically disposed support member 42 to receive the first elongated strip of flexible material or film 18 and the second elongated strip of flexible material or film 20, and the continuous laminated food strip 22 respectively when the food dispensing assembly 14 is operatively mounted on the food dispensing assembly support 28 as described more fully hereinafter.

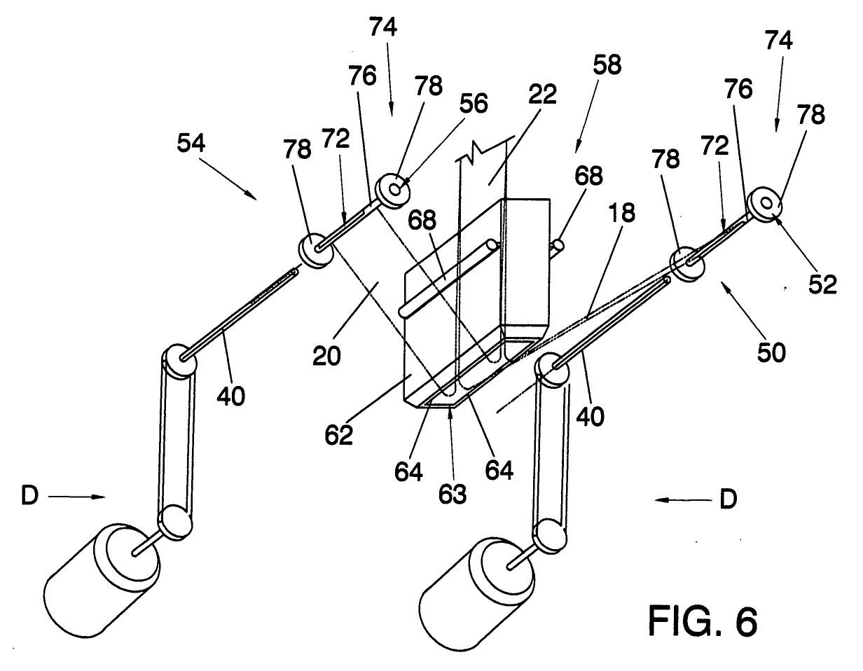

As best shown in FIGS. 5 and 6, the food dispensing assembly 14 comprises a first film strip reel or film take-up device generally indicated as 50 including a centrally disposed pin mounting channel 52 coupled to the leading end portion of the first elongated strip of flexible material or film 18 and a second film strip reel or film take-up device 54 including a centrally disposed pin mounting channel 56 coupled to the leading end portion of the second elongated strip of flexible material or film 20 such that when the first film strip reel or film take-up device 50 and the second film strip reel or film take-up device 54 are mounted on the corresponding rotatable mounting member or pin 40 extending through centrally disposed pin mounting channels 52 and 56 respectively.

The food dispensing assembly 14 further includes a food strip directional control generally indicated as 58 mounted to the substantially horizontally disposed lower wall 48 of the food dispensing assembly support 38 to change the direction of travel of the continuous laminated food strip 22 directed to the food dispensing assembly 14 by a laminated food strip guide comprising an upper arcuate guide member 60 and a substantially vertical guide member 62 disposed within the food storage assembly 12.

The food strip directional control 58 comprises a pair of directional control members each indicated as 62 disposed in spaced relationship to cooperatively form a film slot or channel 63 to receive the continuous laminated food strip 22 and the food products 16 therethrough each directional control member 62 includes a directional control surface 64 to engage the outer surfaces of the first elongated strip of flexible material or film 18 and second elongated strip of flexible material or film 20 when the first film strip reel or film take-up device 50 and the second film strip reel or film take-up device 54 are mounted on the corresponding rotatable mounting member or pin 40.

When so configured, as shown in FIG. 6, a drive means D comprising a motor and belt or suitable mechanism rotates the rotatable mounting members or pins 40 rotating the corresponding first film strip reel or film take-up device 50 and the second film strip reel or film take-up device 54 thereby separating the first elongated strip of flexible material or film 18 and the second elongated strip of flexible material or film 20 allowing the food products 16 to drop or fall onto a conveyor, dish or other surface (not shown).

The preferred angle for redirecting the first elongated strip of flexible material or film 18 and the second elongated strip of flexible material or film 20 is at least 170 degrees. However, the invention contemplates that at least either the first elongated strip of flexible material or film and the second elongated strip of flexible material or film 20 is redirected at least about 90 degrees.

As best shown in FIGS. 2 and 5, the food strip directional control 58 of the food dispensing assembly 14 are formed on the lower portions of side walls 70 that are partially disposed in the centrally disposed laminated strip opening 46 with an assembly support member 68 attached or formed on opposite side walls 70 to engage the upper surface 71 of the substantially horizontally disposed lower wall 48 of the food dispensing assembly support housing 38 on opposite sides of the centrally disposed laminated strip opening 46. As shown in FIGS. 2 and 5, each assembly support member 68 may be disposed between a corresponding pair of retention members each indicated as 67 to cooperatively form an assembly support member receiving channel 69.

Outer end portions of the first elongated strip of flexible material or film 18 and the second elongated strip of flexible material or film 20 are attached or coupled to the first film strip reel or film take-up device 50 and the second film strip reel or film take-up device 54 respectively by an adhesive or through a film slot 72 described hereinafter when deployed. The first film strip reel or film take-up device 50 and the second film strip reel or film take-up device 54 each comprises a spool generally indicated as 74 including a film strip cross-member 76 to receive the first elongated strip of flexible material or film 18 or the second elongated strip of flexible material or film 20 of the continuous laminated food strip 22 having a film retainer element or member 78 disposed on opposite end portions thereof to retain the first elongated strip of flexible material or film 18 or the second elongated strip of flexible material or film 20 of the continuous laminated food strip 22 thereon during the separation process. Each film strip cross-member 76 may include the film slot 72 to receive the outer portion of the corresponding first elongated strip of flexible material or film 18 or second elongated strip of flexible material or film 20.

When the food handling system 10 is stored or refrigerated, each film strip cross-member 76 is disposed within the corresponding groove or channel 36 of the corresponding food dispensing assembly support member 32.

In the present invention, the continuous laminated food strip 22 disposed in the food storage assembly 12 is placed in the cold storage. As previously described, the food dispensing assembly 14 may be at least partially stored with the food storage assembly 12, the food dispensing assembly 14 is disposed at the lower portion of the hollow food product storage enclosure or carton 24. The outer-end portions of the laminated food strips 18 and 20 are connected or coupled to the film take-up devices 50 and 54. When the first elongated strip of flexible material or film 18 and the second elongated strip of flexible material or film 20 of the continuous laminated food strip 22 is reversed backwards at an angle over the first directional control surface 64 and second directional control surface 66 respectively the first elongated strip of flexible material or film 18 and the second elongated strip of flexible material or film 20 of the continuous laminated food strip 22 are separated allowing the food products 16 to separate from the film of the continuous laminated food strip 22.

This results in unpackaging of the food products 16 from the laminated food strip 22. As this delamination takes place, the delamination food product 16 passes onto the conveyor belt or other receiving surface (not shown). Thus, delaminated/unpackaged food products 16 under aseptic conditions may be fed to a grill or conveyor oven or any other heat source directly for the purpose of cooking, without the food being even touched by the cooking staff.

It will thus be seen that the objects set forth above, among those made apparent from the preceding description are efficiently attained and since certain changes may be made in the above construction without departing from the scope of the invention, it is intended that all matter contained in the above description or shown in the accompanying drawing shall be interpreted as illustrative and not in a limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A food dispensing assembly to separate food products from protective packaging comprising a laminated food strip including a pair of flexible film strips to store a plurality of food products therebetween to dispense the food products therefrom, said food dispensing assembly comprises a pair of rotatable film strip take-up devices corresponding to the pair of flexible film strips, each said rotatable film strip take-up device coupled to the leading end portion of the corresponding flexible film strip such that when each said rotatable film take-up device is rotated the distal portions of the flexible film strips are separated from each other releasing the food product having been disposed therebetween.

2. The food dispensing assembly of claim 1 further comprising a food strip directional control including at least one directional control member having a directional control surface to engage a corresponding flexible film strip such that the pair of flexible film strips are separated when said rotatable film take-up devices are rotated releasing the food product having been disposed therebetween.

3. The food dispensing assembly of claim 2 wherein the direction of travel of the flexible film strip engaging said directional control surface is changed at least about ninety degrees.

4. The food dispensing assembly of claim 2 further comprising a food strip directional control corresponding to each of said rotatable film strip take-up devices such that the corresponding directional control surface engages the outer surface of the corresponding flexible film strip separated when said rotatable film strip take-up devices are rotated.

5. The food dispensing assembly of claim 4 wherein the direction of travel of the flexible film strips engaging said correspondingly directional control surface is changed at least about ninety degrees relative to each other.

6. The food dispensing assembly of claim 5 wherein each said rotatable film take-up device is disposed below said corresponding directional control surface in the horizontal plane.

7. The food dispensing assembly of claim 5 wherein at least one of said directional control surface is about at or above said corresponding rotatable film strip take-up reel in the horizontal place.

8. The food dispensing assembly of claim 4 wherein each said rotatable file take-up reel is above said corresponding directional control surface in the horizontal plane.

9. The food dispensing assembly of claim 8 wherein the direction of travel of each flexible film is changed at least about 170 degrees.

10. The food dispensing assembly of claim 4 wherein each said film strip take-up device comprises a spool including a film strip cross-member to receive the corresponding flexible film strip and having a film retainer member disposed on opposite end portions thereof to retain the corresponding flexible film strip thereon during separation of the flexible film strips.

11. The food dispensing assembly of claim 10 wherein each said film strip cross-member includes a film slot to receive the leading portion of the corresponding flexible film strip.

12. A food handling system to store and dispense food products disposed within protective packaging comprising a laminated food strip including a pair of flexible film strips to store a plurality of food products therebetween, said food handling system comprises a food storage assembly to retain the food products to be dispensed therefrom and a food dispensing assembly to separate the food products from the protective packaging to dispense the food products therefrom.

13. The food handling system of claim 12 wherein said food storage assembly comprises a food product storage enclosure to house and support the food products stacked in a fan folded configuration.

14. The food handling system of claim 12 wherein said food storage assembly further includes a food dispensing assembly storage support disposed in the upper portion of a product storage enclosure to support said dispensing assembly.

15. The food handling system of claim 14 wherein said food dispensing assembly storage support comprises a first food dispensing assembly support member and a second food dispensing assembly support member extending between the upper portion of opposite side walls of said food product storage enclosure.

16. The food handling system of claim 15 wherein said first food dispensing assembly support member and said second food dispensing assembly support member each includes a groove to receive and support a portion of said food dispensing assembly.

17. The food handling system of claim 12 wherein said food storage assembly further includes a food dispensing assembly support disposed on the lower portion of a food product storage enclosure to operatively support said food dispensing assembly when deployed to separate the food products from said food dispensing assembly of said food handling system.

18. The food handling system of claim 17 wherein said food dispensing assembly comprises a pair of rotatable film strip take-up devices corresponding to the pair of flexible film strips, each said rotatable film strip take-up device coupled to the leading end portion of the corresponding flexible film strip such that when each said rotatable film take-up device is rotated the distal portions of the flexible film strips are separated from each other releasing the food product having been disposed therebetween.

19. The food handling system of claim 18 wherein said food dispensing assembly support comprises a food dispensing assembly support housing having a laminated strip opening to receive the laminated food strip therethrough when said food dispensing assembly is operatively mounted on said food dispensing assembly support.

20. The food handling system of claim 19 wherein said food dispensing assembly further includes a laminated food strip guide to direct the laminated food strip to said laminated strip opening.

21. The food handling system of claim 20 wherein said laminated food strip guide comprises an upper arcuate guide member and a substantially vertical guide member disposed within said food storage assembly.

22. The food handling system of claim 18 wherein said food dispensing assembly support housing further includes a pair of mounting members to receive a corresponding rotatable film strip take-up device take-up.

23. The food handling system of claim 18 further comprising a food strip directional control including at least one directional control member having a directional control surface to engage a corresponding flexible film strip such that the pair of flexible film strips are separated when said rotatable film take-up devices are rotated releasing the food product having been disposed between.

24. The food handling system of claim 23 wherein said food dispensing assembly support comprises a food dispensing assembly support housing having at least one film separation slot and a laminated strip opening to receive the corresponding flexible film strip and the laminated food strip respectively therethrough when said food dispensing assembly is operatively mounted on said food dispensing assembly support.

25. The food dispensing assembly of claim 18 further comprising a food strip directional control corresponding to each of said rotatable film strip take-up devices such that the corresponding directional control surface engages the outer surface of the corresponding flexible film strip separated when said rotatable film strip take-up devices are rotated.

26. The food handling system of claim 25 wherein said food dispensing assembly support comprises a food dispensing assembly support housing having a pair of film separation slots and a laminated strip opening to receive the corresponding flexible film strip and the laminated food strip respectively therethrough when said food dispensing assembly is operatively mounted on the food dispensing assembly support.
